(19) United States
(12) Patent Application Publication
(10) Pub. No.: US 2022/0366394 A1
(43) Pub. Date: Nov. 17, 2022

(54) VEHICLE PAYMENT COMMUNICATIONS SYSTEMS AND METHODS

(71) Applicant: Ford Global Technologies, LLC, Dearborn, MI (US)

(72) Inventors: Himanshu Verma, Farmington Hills, MI (US); Finn Finn Tseng, Ann Arbor, MI (US)

(73) Assignee: Ford Global Technologies, LLC, Dearborn, MI (US)

(21) Appl. No.: 17/321,570

(22) Filed: May 17, 2021

(51) Int. Cl. G06Q 20/22; G06Q 20/08; G06Q 20/20; H04W 4/46; H04W 4/24

(52) U.S. Cl. CPC G06Q 20/22; G06Q 20/085; G06Q 20/202; G06Q 20/204; H04W 4/46; H04W 4/24; G06Q 50/06

(57) ABSTRACT

Vehicle payment communications systems and methods are disclosed herein. An example method can include identifying a shared payment device, the shared payment device being a connected vehicle, transmitting a shared payment request to the shared payment device, the shared payment device authorizing a shared payment for the payment of a good or service to a merchant, receiving an indication that the shared payment has been authorized and completed in accordance with the shared payment request, and obtaining the good or service from the merchant.

### BACKGROUND

Users may forget or misplace their forms of payment and not realize this until attempting to pay for a good or service. For example, a user may realize that they are unable to pay for fuel at a fueling station because they left their wallet at home. The user's only option is to abandon their task and retrieve their wallet, contact another person to bring them a payment option, or ask the merchant for assistance.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a schematic diagram of example uses cases for implementing aspects of the present disclosure.

FIG. 3 is a flowchart of an example method of the present disclosure.

FIG. 4 is a flowchart of another example method of the present disclosure related to FIG. 3.

FIG. 5 is a flowchart of an additional example method of the present disclosure.

### DETAILED DESCRIPTION

### Overview

The systems and methods disclosed herein are directed to vehicle-based payment services. A connected vehicle of the present disclosure can function as a shared payment device that may authorize a request for a shared payment from a user, another connected vehicle, and/or a mobile device. In one example, a user may borrow another's vehicle. When fueling this vehicle, the user may want the owner of the vehicle to pay for the fuel. The user can request that the owner of the vehicle authorize the vehicle to process a shared payment request. The shared payment request can include not only the amount requested but also payment instructions for paying a merchant for a good or service such as fuel. If approved, the user can obtain the fuel. An acknowledgment can be transmitted to the vehicle or a smart device of the user to inform them that the transaction was approved.

In another example, a driver of their vehicle (a first vehicle) may forget their wallet at home. Rather than having to retrieve their wallet, the driver can request that their vehicle approve a shared payment request on behalf of the driver. In yet another example, if the first vehicle is not configured to authorize shared payment requests, the first vehicle can request that a second connected vehicle may process the shared payment request. If approved, the shared payment device (e.g., the second connected vehicle) can authorize the shared payment to a merchant and transmit an indication or acknowledgment to the first vehicle. The driver can then fuel the vehicle.

In some instances, the shared payment may be provided to a smart device (such as a mobile device (e.g., a smartphone or the like)) of the driver of the first vehicle. In one example, a connected vehicle can approve a shared payment request and transmit an amount of money to a smart device. The smart device can utilize the payment for contactless payment at a point-of-sale terminal for a good or service.

### Illustrative Embodiments

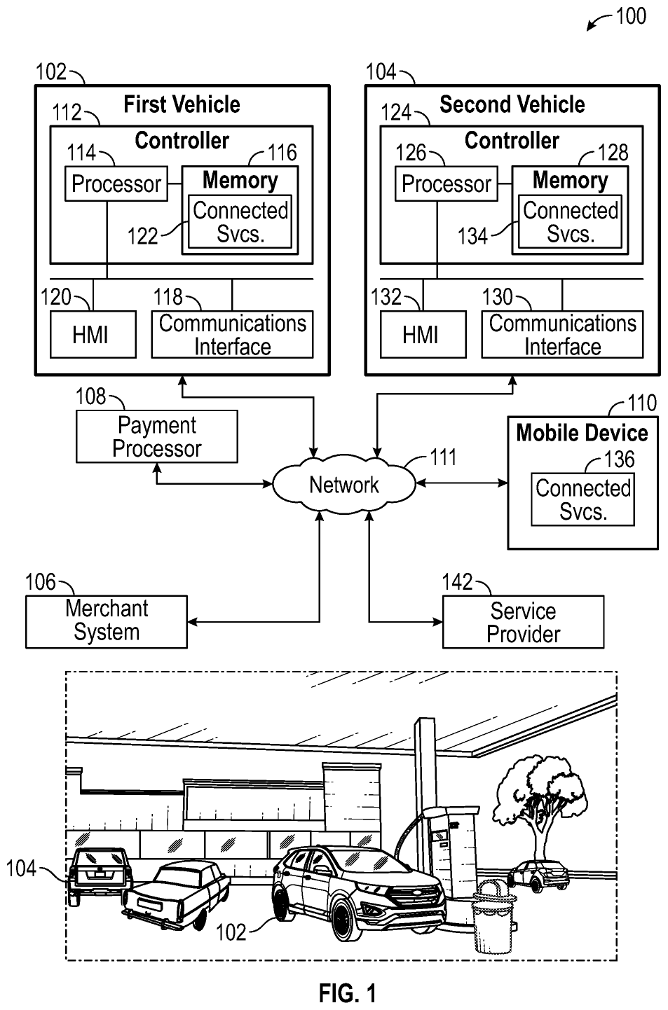

Turning now to the drawings, FIG. 1 depicts an illustrative architecture 100 in which techniques and structures of the present disclosure may be implemented. The architecture 100 can include a first vehicle 102, a second vehicle 104, a merchant system 106, a payment processor 108, a mobile device 110, and a network 111. Some or all of these components in the architecture 100 can communicate with one another directly and/or using the network 111. The network 111 can include combinations of networks that enable the components in the architecture 100 to communicate with one another. The network 111 may include any one or a combination of multiple different types of networks, such as cable networks, the Internet, wireless networks, and other private and/or public networks. In some instances, the network 111 may include cellular, Wi-Fi, or Wi-Fi direct. The network 111 can include a vehicle-to-vehicle communications link, a vehicle-to-infrastructure communications link, and/or a vehicle-to-everything communications link.

The first vehicle 102 can include a controller 112 having a processor 114 and memory 116, as well as a communications interface 118 for accessing the network 111. The processor 114 executes instructions stored in memory 116 to perform shared payment operations disclosed herein. The first vehicle 102 can include a human-machine interface (HMI) 120 such as an infotainment system that allows a user to request shared payments, authorize shared payment requests from other vehicles or devices, and/or receive approvals of shared payments. When referring to functions performed by the controller 112, this includes the execution of instructions stored in the memory 116. For example, the memory 116 can store instructions, such as a connected services application 122 (e.g., Ford Pass™).

In some instances, the second vehicle 104 is configured similarly to the first vehicle 102. The second vehicle 104 can include a controller 124 having a processor 126 and memory 128, as well as a communications interface 130 for accessing the network 111. The processor 126 executes instructions stored in memory 128 to perform shared payment operations disclosed herein. The second vehicle 104 can include a human-machine interface 132 such as an infotainment system that allows a user to request shared payments, authorize shared payments requests from other vehicles or devices, and/or receive approvals of shared payments. When referring to functions performed by the controller 124, this includes the execution of instructions stored in the memory 128. For example, the memory 128 can store instructions, such as a connected services application 134 (e.g., Ford Pass™).

The merchant system 106 can include any point-of-sale terminal where a user or vehicle can pay for a good or service. For example, the merchant system 106 can include a gas pump. The payment processor 108 generally refers to any backend system that processes payments or transactions for a good or service offered by the merchant system 106. For example, if the merchant system 106 is associated with a gas station, the good is fuel, and the payment processor 108 can include any payment processor for which the merchant system 106 is authorized to perform transactions such as a credit card processor, a bank, or other monetary institution or intermediary. When requested, the payment processor 108 can approve a transaction amount for a good or service.

The mobile device 110 can include a Smartphone or tablet that can also load a connected services application 136 such as Ford Pass™. The Smartphone can communicate with the first vehicle 102 over the network 111 to transmit shared payment requests and receive acknowledgments of transaction approvals.

It will be understood that the connected services applications that execute on the first vehicle, the second vehicle, and/or the mobile device 110 can be orchestrated using a service provider 142. The service provider 142 can be operated by an original equipment manufacturer (OEM).

For context, the first vehicle 102 and the second vehicle 104 are located at a gas station 138 associated with the merchant system 106. The first vehicle 102 is attempting to obtain fuel at a gas pump 140 comprising a point of sale. The second vehicle 104 can be located anywhere in proximity to the first vehicle 102, such as at an adjacent gas pump or in a nearby parking spot.

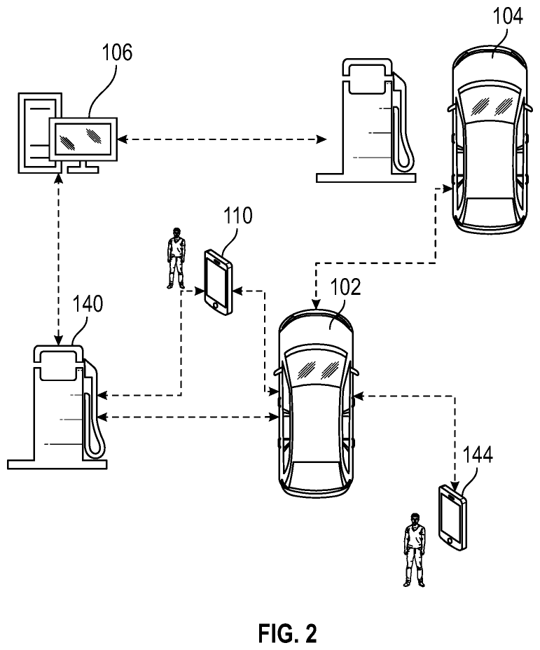

Referring now to FIGS. 1 and 2 collectively, in an example use case, a driver of the first vehicle 102 may desire to pay for fuel at the gas pump 140. Realizing that the driver does not have a form of payment, the driver can activate the HMI 120 to enter a shared payment request prior to pumping fuel. For example, the shared payment request may comprise the driver specifying that they wish to purchase $50.00 or fifteen gallons of fuel. In another example, the driver may wish to be pre-authorized to purchase any amount of fuel. The shared payment request can include transaction-related data, such as a fuel cost or authorization amount, as well as merchant information such as a point-of-sale identifier or merchant identifier.

The controller 112 receives the request and processes a shared payment with the payment processor 108. When the transaction is approved by the payment processor 108, an acknowledgment may be received by from the payment processor 108 and/or the merchant system 106. In some instances, the merchant system 106 activates the gas pump 140 to allow the driver to fill their vehicle with an amount of fuel.

In another use case involving FIG. 2, the driver can utilize the HMI 120 to determine or search for other connected vehicles in the area, such as the second vehicle 104. Thus, the controller 112 can identify a shared payment device, the shared payment device being a connected vehicle such as the second vehicle 104. The first vehicle 102 can transmit a shared payment request to the second vehicle 104. The second vehicle 104 may authorize a shared payment for the payment of a good or service to a merchant using the method above. The second vehicle 104 can authorize the purchase of fuel in a monetary amount specified in the shared payment request. Identifiers for the gas pump 140 and the merchant can be forwarded to the payment processor 108. When the amount is authorized, an acknowledgment can be transmitted to the second vehicle 104, the first vehicle 102, and/or the gas pump 140 or merchant system 106. In one example, the gas pump 140 can receive the acknowledgment and activate the dispensing of fuel. In another example, the merchant system 106 receives the acknowledgment and activates the gas pump 140 for use.

In yet another use case, a child driver may borrow the first vehicle 102 from a parent. The driver may need to refuel the first vehicle 102. The child driver can use the HMI 120 of the first vehicle 102 to transmit a payment request to their parent. The parent can receive the shared payment request from the first vehicle 102 on their mobile device 144. When the transaction is authorized, the driver can obtain fuel from the gas pump 140.

In another use case example, the monetary amount specified in the shared payment request can be transmitted directly to the mobile device 110 of the user. The mobile device 110 can be used to complete a transaction at a point-of-sale terminal. The monetary amount can be represented as a token or coupon for payment in some instances.

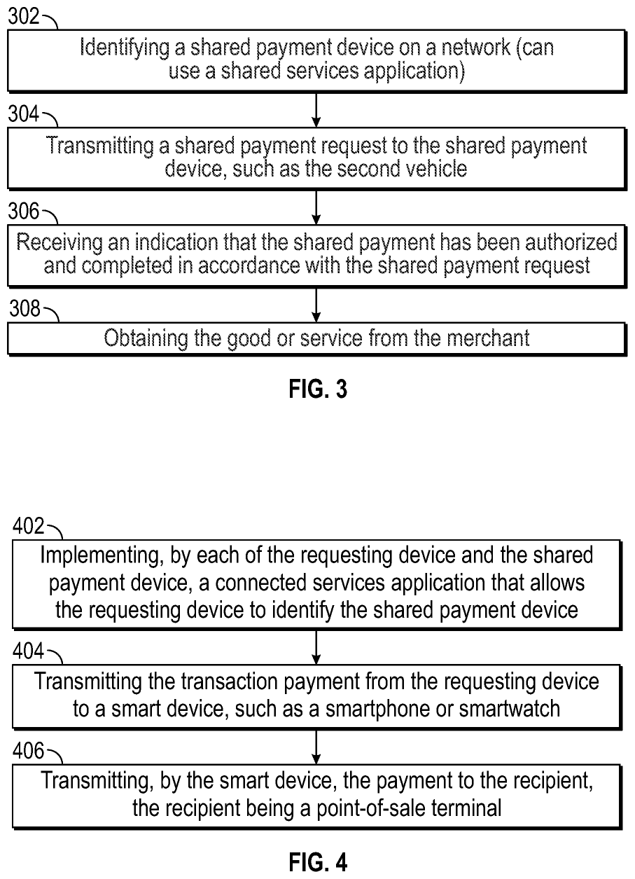

FIG. 3 is a flowchart of an example method of the present disclosure. For context, the method can be performed by a requesting device, such as a mobile device or a first connected vehicle (e.g., a vehicle requesting a shared payment). The method can include a step 302 of identifying a shared payment device. The shared payment device can be a connected vehicle. The identification of the shared payment device can include identifying the connected vehicle when it is connected over a network using a connected services application. That is, both the first vehicle and the second vehicle can implement a connected services application that allows the vehicles to identify one another and perform shared payment operations. The connected services application at least allows the requesting device to identify the shared payment device. The shared payment device is identifiable on a network and the network can be a vehicle-to-vehicle communication link.

Next, the method can include a step 304 of transmitting a shared payment request to the shared payment device, such as the second vehicle. The shared payment device authorizing a shared payment for the payment of a good or service to a merchant. The shared payment request can include any details necessary to authorize a particular transaction. In other instances, the shared payment request can include only the transaction amount.

The method can include a step 306 of receiving an indication that the shared payment has been authorized and completed in accordance with the payment request. That is, the first vehicle receives a message or other confirmation that the shared payment was authorized by the second vehicle. Finally, the method can include a step 308 of obtaining the good or service from the merchant. For example, a driver can obtain fuel from a gas pump.

FIG. 4 is a flowchart of a related method that includes additional features that can be used in combination with the method of FIG. 3. The method can include a step 402 of implementing, by each of the requesting device and the shared payment device, a connected services application that allows the requesting device to identify the shared payment device. Next, the method can include a step 404 of transmitting the transaction payment from the requesting device to a smart device, such as a Smartphone or Smartwatch. The method can include a step 406 of transmitting, by the smart device, the payment to the recipient, the recipient being a point-of-sale terminal.

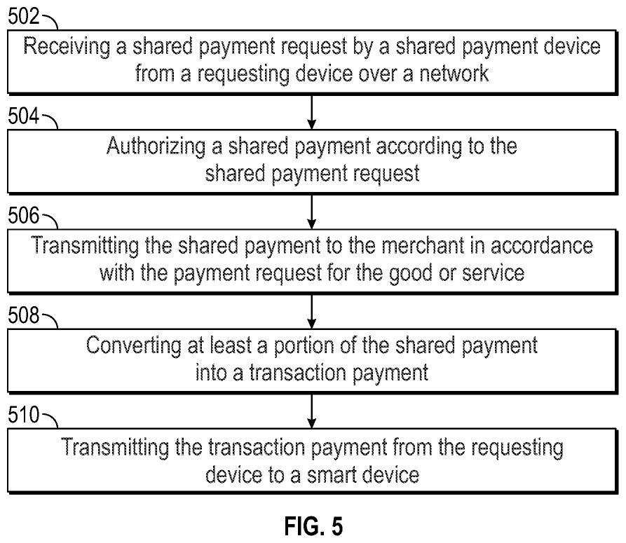

FIG. 5 is a flowchart of an example method. The method can be performed by a shared payment device such as a connected vehicle. The method can include a step 502 of receiving a shared payment request by a shared payment device from a requesting device over a network. As noted above, the network can include any network that includes V2V communication. The shared payment device may be a connected vehicle that can be identified on the network. In some instances, the shared payment request can comprise an identification of a good or service, a cost of the good or service, and a merchant. In other configurations, the shared payment request may include only a request for a determined amount of money.

Next, the method can include a step 504 of authorizing a shared payment according to the shared payment request. This can include the shared payment device processing a transaction with a payment processor. It will be understood that the authorization of the shared payment can be based on credit or funds available to the shared payment device.

In some instances, the method can include a step 506 of transmitting the shared payment to the merchant in accordance with the payment request for the good or service. As noted above, the shared payment may by transmitted to a point-of-sale terminal of the merchant. The method can include a step 508 of converting at least a portion of the shared payment into a transaction payment, as well as a step 510 of transmitting the transaction payment from the requesting device to a smart device. For example, the requesting party may request a first amount from the shared payment device, such as $100.00. The receiving party may select only a portion of the first amount for payment to the merchant and retain the remainder.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching.

What is claimed is:

1. A method comprising:
identifying a shared payment device comprising a connected vehicle;
transmitting a shared payment request to the shared payment device, the shared payment device authorizing a shared payment for a good or service to a merchant;
receiving an indication that the shared payment has been authorized and completed in accordance with the shared payment request; and
obtaining the good or service from the merchant.

2. The method according to claim 1, wherein the shared payment device is identifiable on a network comprising a vehicle-to-vehicle communication link.

3. The method according to claim 1, wherein the shared payment request is transmitted by a requesting device comprising another connected vehicle or a smart device.

4. The method according to claim 3, further comprising implementing, by each of the requesting device and the shared payment device, a connected services application that allows the requesting device to identify the shared payment device.

5. The method according to claim 4, wherein the requesting device comprises another connected vehicle, further comprising transmitting at least a portion of the shared payment from the requesting device to the smart device.

6. The method according to claim 5, further comprising transmitting, by the smart device, the shared payment to a recipient, the recipient being a point-of-sale terminal.

7. A system comprising:
a memory; and
a processor for executing instructions stored in the memory that configure the processor to:
identify a shared payment device comprising a connected vehicle;
transmit a shared payment request to the shared payment device, the shared payment device authorizing a shared payment for a good or service to a merchant; and
receive an indication that the shared payment has been authorized and completed in accordance with the shared payment request.

8. The system according to claim 7, wherein the processor is configured to provide a transaction payment to a recipient from the shared payment device.

9. The system according to claim 7, wherein the shared payment request is received by a requesting device, the requesting device comprising another connected vehicle or a smart device.

10. The system according to claim 9, wherein the shared payment device is connected to a network that provides a vehicle-to-vehicle communication link.

11. The system according to claim 10, further comprising a connected services application executed by each of the requesting device and the shared payment device, the connected services application allowing the requesting device to identify the shared payment device over the network.

12. The system according to claim 11, wherein the requesting device is a vehicle, wherein the processor is configured to transmit at least a portion of the shared payment from the requesting device to the smart device.

13. The system according to claim 12, wherein the smart device is configured to transmit the at least a portion of the shared payment to a recipient, the recipient being a point-of-sale terminal.

14. A method comprising:
receiving a shared payment request by a shared payment device from a requesting device over a network, the shared payment device being a connected vehicle that is identifiable on the network, the shared payment request comprising an identification of a good or service, a cost of the good or service, and a merchant;
authorizing a shared payment according to the shared payment request; and
transmitting the shared payment to the merchant in accordance with the shared payment request for the good or service.

15. The method according to claim 14, wherein the shared payment is transmitted to a point-of-sale terminal of the merchant.

16. The method according to claim 14, further comprising identifying the shared payment device on the network, the network being a vehicle-to-vehicle communication link.

17. The method according to claim 16, further comprising implementing, by each of the requesting device and the shared payment device, a connected services application that allows the requesting device to identify the shared payment device.

18. The method according to claim 17, further comprising:
converting at least a portion of the shared payment into a transaction payment; and
transmitting the transaction payment from the requesting device to a smart device.

19. The method according to claim 18, further comprising transmitting, by the smart device, the shared payment to a recipient, the recipient being a point-of-sale terminal.
